(19) United States
(12) Patent Application Publication
(10) Pub. No.: US 2012/0318201 A1
(43) Pub. Date: Dec. 20, 2012

(54) Fluid Delivery System for a Pet

(75) Inventor: Jason Sanders, San Francisco, CA (US)

(73) Assignee: PET PEEVE SOLUTIONS LLC, San Francisco, CA (US)

(21) Appl. No.: 13/160,454

(22) Filed: Jun. 14, 2011

(51) Int. Cl. A01K 7/06

(52) U.S. Cl. 119/72

(57) ABSTRACT

A fluid delivery system for a pet includes a reservoir for a fluid and a fluid delivery assembly connected to the reservoir. The fluid delivery assembly includes a fluid release roller, a housing encasing the fluid release roller, and an engagement surface mated with the fluid release roller to create a fluidic seal in response to static pressure upon the fluid release roller from the fluid. The fluidic seal is released to allow a flow of the fluid in response to dynamic pressure applied to the fluid release roller by a pet.

### FIELD OF THE INVENTION

This invention relates generally to pet supplies. More particularly, this invention relates to a fluid delivery system for a pet.

### BACKGROUND OF THE INVENTION

Domestic pets typically drink fluids out of a bowl. There are a number of shortcomings associated with this approach. First, the fluid is commonly spilled; spillage may result from a pet owner kicking a bowl or a pet's sloppy consumption of a fluid in the bowl. Another problem with this approach is that the fluid can become polluted from pet backwash and/or ambient debris that falls in the bowl. These problems result in the use of relatively small bowls, which have to be frequently re-filled. Another problem with the use of a bowel is that a pet's hair may be dipped into the bowl. This can result in the hair being stained or otherwise discolored.

In view of the foregoing, it is desirable to provide an improved pet fluid delivery system that reduces hair stains, spillage and re-fill activity, while maintaining fluid purity.

### SUMMARY OF THE INVENTION

A fluid delivery system for a pet includes a reservoir for a fluid and a fluid delivery assembly connected to the reservoir. The fluid delivery assembly includes a fluid release roller, a housing encasing the fluid release roller, and an engagement surface mated with the fluid release roller to create a fluidic seal in response to static pressure upon the fluid release roller from the fluid. The fluidic seal is released to allow a flow of the fluid in response to dynamic pressure applied to the fluid release roller by a pet.

### BRIEF DESCRIPTION OF THE FIGURES

The invention is more fully appreciated in connection with the following detailed description taken in conjunction with the accompanying drawings, in which:

FIG. 1 illustrates a pet fluid delivery system configured in accordance with an embodiment of the invention.

FIG. 2 is an exploded view of a fluid delivery assembly configured in accordance with an embodiment of the invention.

FIG. 3 is a side phantom view of a fluid delivery assembly configured in accordance with an embodiment of the invention.

FIG. 4 illustrates an embodiment of a mounting plate configured in accordance with an embodiment of the invention.

FIG. 5 is a side view of a hooked mounting plate connected to an adjustable mounting plate in a first orientation in accordance with an embodiment of the invention.

FIG. 6 illustrates a perspective view of a hooked mounting plate utilized in accordance with an embodiment of the invention.

FIG. 7 illustrates an adjustable mounting plate utilized in accordance with an embodiment of the invention.

FIG. 8 is a side view of a hooked mounting plate connected to an adjustable mounting plate in a second orientation in accordance with an embodiment of the invention.

Like reference numerals refer to corresponding parts throughout the several views of the drawings.

### DETAILED DESCRIPTION OF THE INVENTION

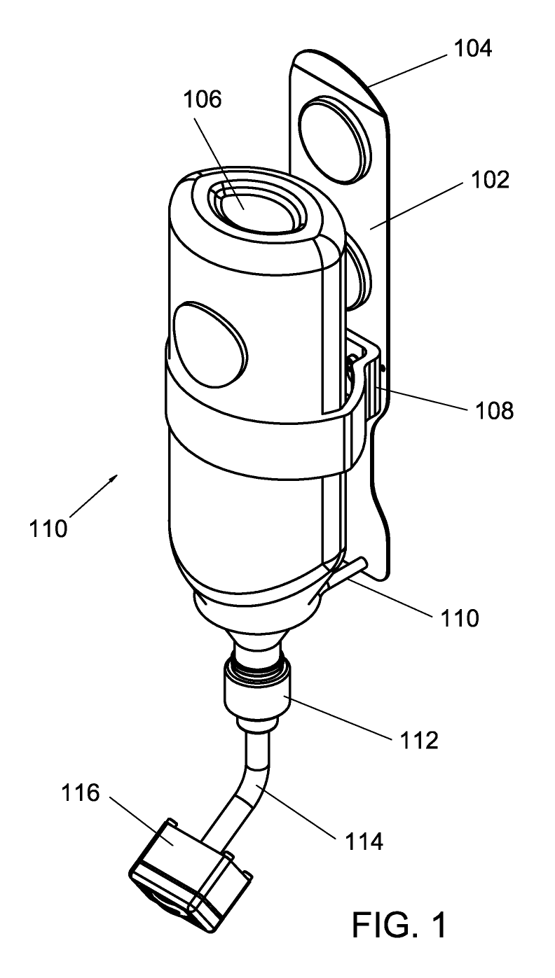

FIG. 1 illustrates a pet fluid delivery system 100. The system 100 includes a mounting plate 102. The mounting plate may be magnetized for attachment to a refrigerator, dishwasher or the like. A lip 104 may be used in this embodiment to facilitate the release of the mounting plate 102 from a surface.

The system 100 also includes a reservoir 106. The reservoir 106 may be affixed to the mounting plate 102 using one or more support mechanisms. FIG. 1 illustrates a first support mechanism 108 and a second support mechanism 110. In this embodiment, the first support mechanism 108 has a belt-like configuration. The first support mechanism may be rubber, bamboo or any number of other substances. FIG. 1 also illustrates a second support mechanism 110. The second support mechanism 110 may have a clamp-like configuration formed of metal, plastic tubing or any number of other substances.

The reservoir 106 may include a cap 112. A fluid conduit 114 may extend from the cap 112 and terminate in a fluid delivery assembly 116. The fluid conduit 114 is optional, but is generally desirable to provide a more convenient orientation for a pet accessing the reservoir 106.

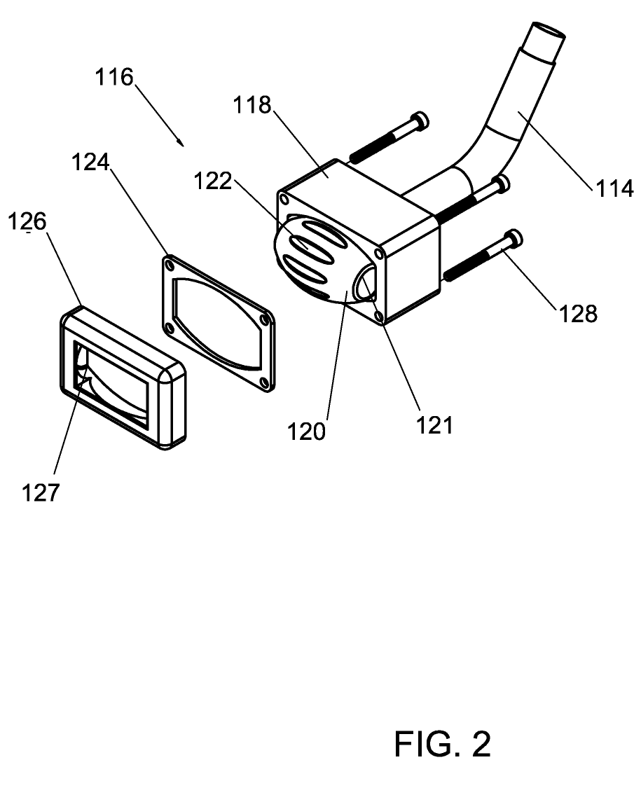

FIG. 2 is an exploded view of the fluid delivery assembly 116. In one embodiment, the fluid delivery assembly 116 includes a housing 118 that encases a fluid release roller 120. Applicant has identified that a fluid release roller with prolate spheroid dimensions is desirable. A prolate spheriod has an egg-like or football-like configuration. The ends of the prolate spheroid may be cut off for convenience, thereby rendering one or more flat terminal surfaces 121.

A cover 126 may be attached to the housing 118 through a gasket 124. The cover 126 includes an engagement surface 127 to mate with the fluid release roller. Screws 128 may be used to hold the assembly 116 together.

One of skill in the art will appreciate that with this configuration, a fluidic seal is formed in response to static pressure upon the fluid release roller 120 from fluid in the reservoir 106. On the other hand, the fluidic seal is released to allow a flow of the fluid in response to dynamic pressure applied to the fluid release roller by a pet. For example, a pet applying dynamic pressure in the form of a licking pressure on the fluid release roller will result in a fluid release that is applied to the tongue of the pet. This dynamic pressure may be facilitated through traction features 122 on the fluid release roller 120. The traction features 122 may be grooves, protrusions and the like.

Thus, the invention provides a mechanism for a pet to consume a fluid. Advantageously, the system provides an enclosed environment. As a result, prior art problems of spillage are eliminated. In addition, the enclosed environment minimizes or prevents pollution of the fluid. Another advantage of the system is that a relatively large reservoir may be used since there are no concerns regarding spillage or fluidic pollution. Yet another advantage of the system is that a pet does not dip hair into a bowl. Consequently hair stains and discoloration are avoided.

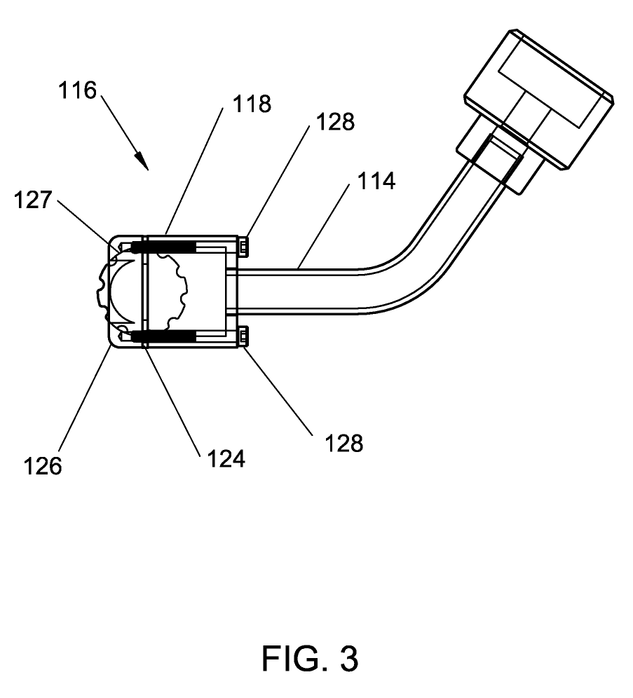

FIG. 3 is a side phantom view of the fluid delivery assembly 116. The figure illustrates the fluid conduit 114 attached to the housing 118. The figure also illustrates the cover 126, engagement surface 127 and gasket 124. The figure also illustrates the fluid release roller 120 and its traction features 122. It can be appreciated that dynamic pressure against the fluid release roller 120 presses the fluid release roller 120 into the housing 118, which allows fluid to pass to the pet.

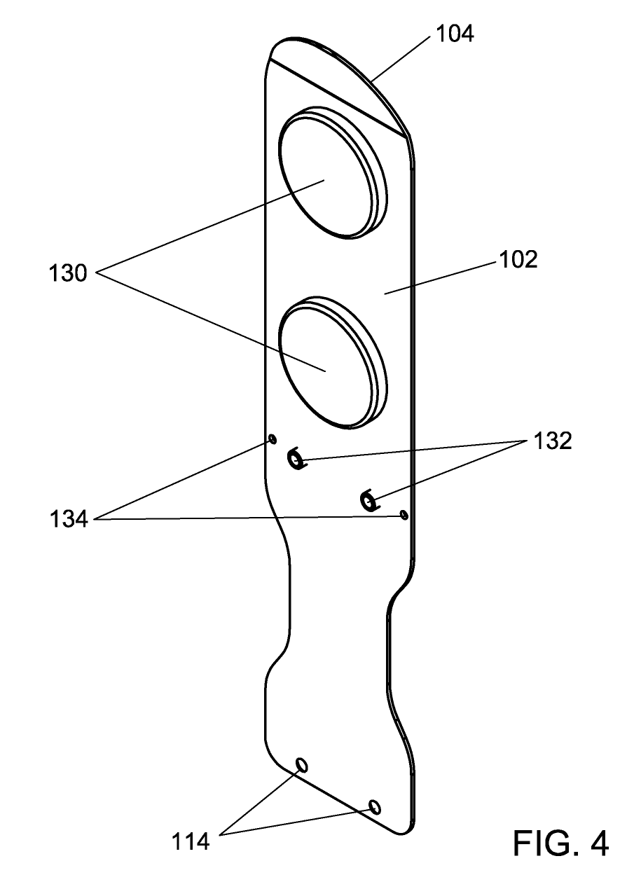

FIG. 4 illustrates a mounting plate 102. The entire mounting plate 102 may be formed of a magnetic material. Alternately, or in addition, separate magnets 130 may be used to provide the requisite magnetization. The figure also illustrates first mounting apertures 132, second mounting apertures 134 and third mounting apertures 136. The first mounting apertures 132 or the second mounting apertures 134 may be used to affix the first support mechanism 108, while the third mounting apertures 136 may be used to affix the second support mechanism.

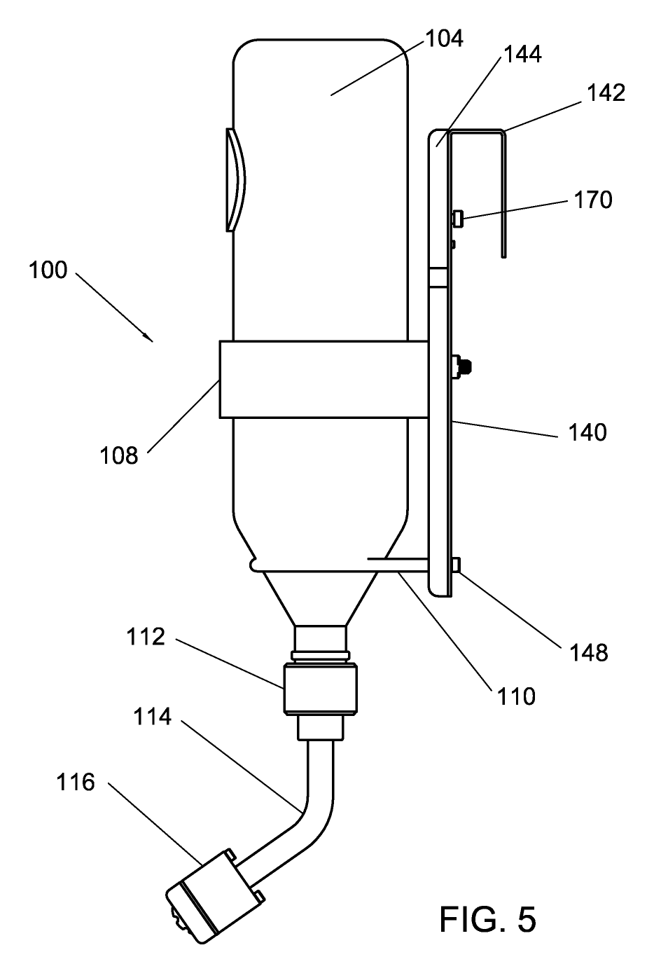

FIG. 5 is a side view of the system 100. In this embodiment the mounting plate 140 has a hook 142 for easy attachment to a door or similar structure. This embodiment includes an adjustable mounting plate 144, which is attached to the mounting plate 140. In one embodiment, the adjustable mounting plate 144 is rotatably attached to the mounting plate 140 through a clamp bolt 170 or other fastener. In the configuration of FIG. 5 the adjustable mounting plate 144 is in a relatively low vertical orientation with the second support mechanism 10 engaging affixation apertures 148.

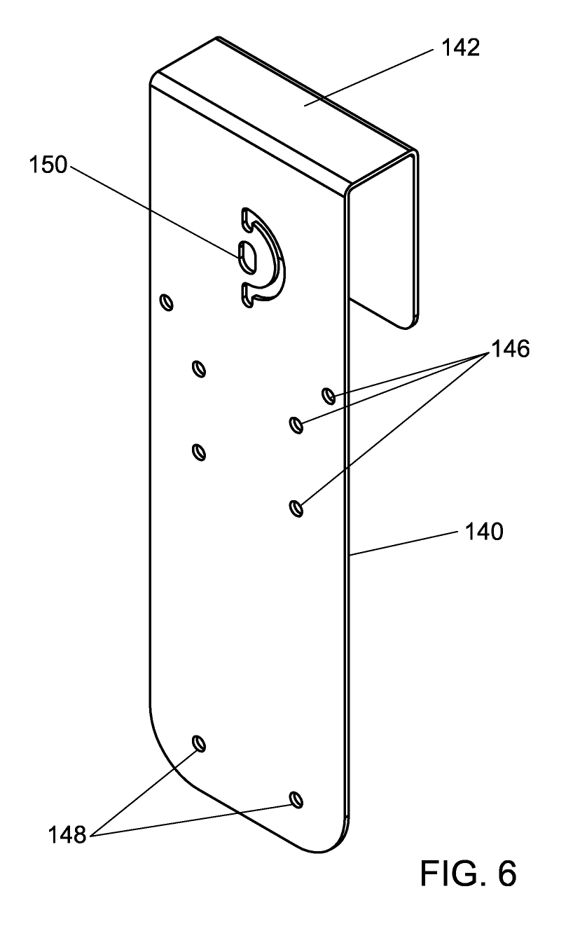

FIG. 6 is a perspective view of the mounting plate 140. The mounting plate 140 includes a hook 142. The mounting plate 140 also includes affixation apertures 148 and mounting apertures 146. Clamp bolt aperture 150 receives a clamp bolt 170 used to swivel the adjustable mounting plate 144.

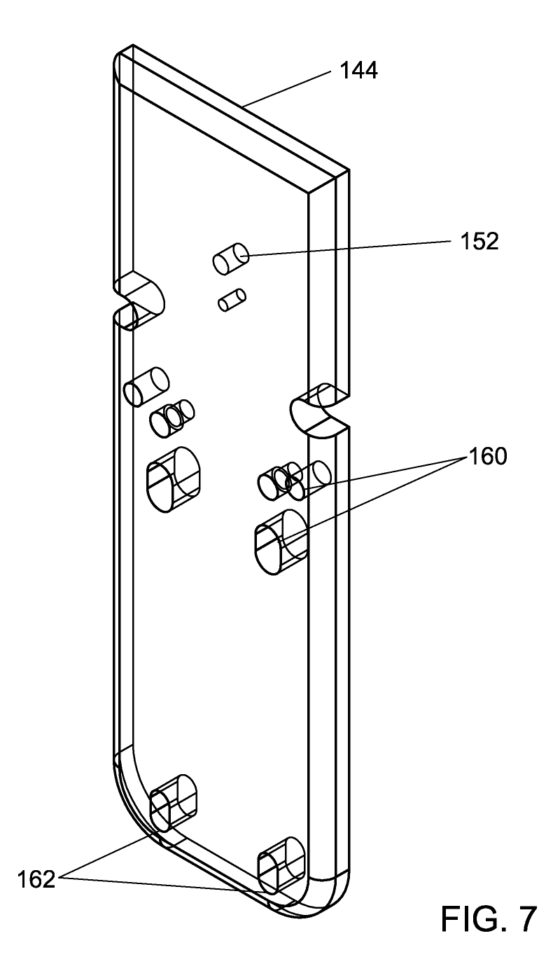

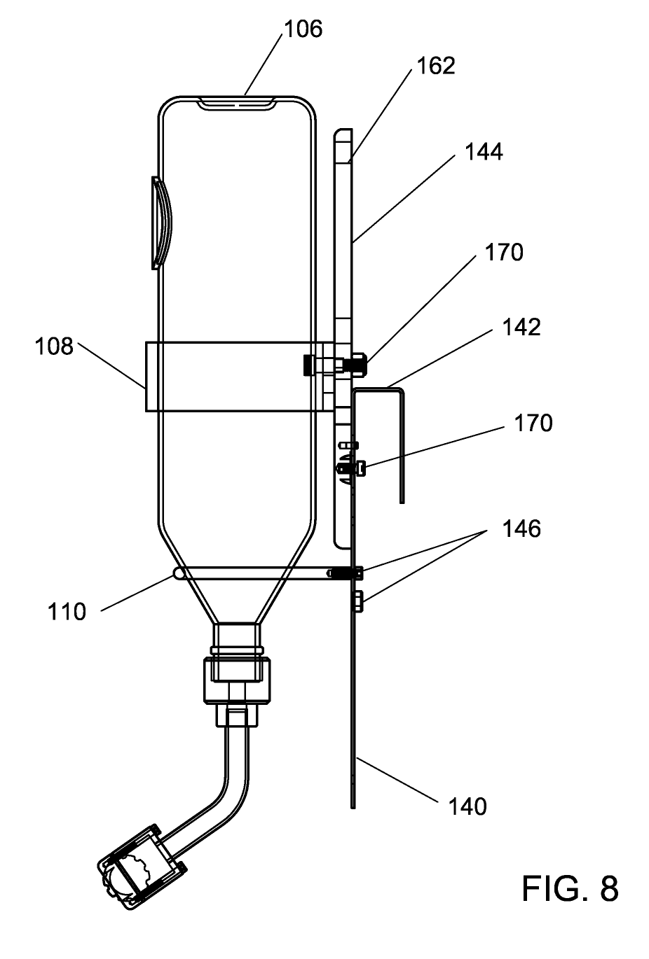

FIG. 7 illustrates an adjustable mounting plate 144 with lower apertures 162 for alignment with affixation apertures 148 of mounting plate 140. The adjustable mounting plate 144 also includes apertures 160 for alignment with apertures 146 of mounting plate 140. An adjustable mounting plate clamp bolt aperture 152 receives clamp bolt 170. This allows the adjustable mounting plate to swivel to a second position, as shown in FIG. 8.

Observe in FIG. 8 that the clamp bolt 170 is positioned above the hook 142, instead of below the hook 142, as is the case in FIG. 5. Also observe that the lower apertures 162 are now in a relatively high position, as is the reservoir 106. In this case, the second support mechanism 110 may be directly affixed to apertures 146 of mounting plate 140. Thus, the adjustable mounting plate may be used to hold the reservoir at a first height when in a first orientation (e.g., FIG. 5) and at a second height when in a second orientation (e.g., FIG. 8).

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A fluid delivery system for a pet, comprising:
a reservoir for a fluid; and
a fluid delivery assembly connected to the reservoir, wherein the fluid delivery assembly includes
a fluid release roller,
a housing encasing the fluid release roller, and
an engagement surface mated with the fluid release roller to create a fluidic seal in response to static pressure upon the fluid release roller from the fluid, wherein the fluidic seal is released to allow a flow of the fluid in response to dynamic pressure applied to the fluid release roller by a pet.

2. The fluid delivery system of claim 1 wherein the fluid release roller includes prolate spheroid dimensions.

3. The fluid delivery system of claim 2 wherein the fluid release roller includes engagement surfaces.

4. The fluid delivery system of claim 3 wherein the engagement surfaces are grooves.

5. The fluid delivery system of claim 1 further comprising a mounting plate attached to the reservoir.

6. The fluid delivery system of claim 5 wherein the mounting plate is magnetized.

7. The fluid delivery system of claim 5 further comprising a first support mechanism attached to the mounting plate to support the reservoir.

8. The fluid delivery system of claim 7 further comprising a second support mechanism attached to the mounting plate to support the reservoir.

9. The fluid delivery system of claim 5 wherein the mounting plate has a lip.

10. The fluid delivery system of claim 5 wherein the mounting plate has a hook.

11. The fluid delivery system of claim 5 further comprising an adjustable mounting plate attached to the mounting plate.

12. The fluid delivery system of claim 11 wherein the adjustment mounting plate is rotatably attached to the mounting plate.

13. The fluid delivery system of claim 12 wherein the adjustable mounting plate in a first orientation holds the reservoir at a first height and the adjustable mounting plate in a second orientation holds the reservoir at a second height.

14. The fluid delivery system of claim 1 wherein the fluid reservoir includes a cap.

15. The fluid delivery system of claim 14 further comprising a fluid conduit connected between the cap and the fluid delivery assembly.

16. The fluid delivery system of claim 1 further comprising a gasket positioned between the housing and the engagement surface.

17. The fluid delivery system of claim 16 wherein the engagement surface is positioned in a cover affixed to the housing.
